(19) United States
(12) Patent Application Publication
(10) Pub. No.: US 2013/0195371 A1
(43) Pub. Date: Aug. 1, 2013

(54) METHOD FOR CODING AND FOR RECONSTRUCTION OF A BLOCK OF AN IMAGE SEQUENCE AND CORRESPONDING DEVICES

(71) Applicants: Aurelie Martin, Paris (FR); Dominique Thoreau, Cesson- Sevigne (FR); Edouard Francois, Bourg des Comptes (FR); Jerome Vieron, Paris (FR)

(72) Inventors: Aurelie Martin, Paris (FR); Dominique Thoreau, Cesson- Sevigne (FR); Edouard Francois, Bourg des Comptes (FR); Jerome Vieron, Paris (FR)

(73) Assignee: THOMSON LICENSING, Issy Les Moulineaux (FR)

(21) Appl. No.: 13/577,994

(22) PCT Filed: Feb. 9, 2011
(86) PCT No.: PCT/EP11/51896

§ 371 Date: Oct. 15, 2012

(30) Foreign Application Priority Data
Feb. 11, 2010 (FR) 1050963

(51) Int. Cl. G06T 9/00

(52) U.S. Cl. CPC G06T 9/004
USPC 382/238

(57) ABSTRACT

A method for coding a current block is disclosed. The method comprises:
determining a prediction block from the current block,
determining a residue block by extracting from the current block the prediction block, and
coding the residue block.

The prediction block from the current block is determined according to the following steps for:
determining an initial prediction block from motion data and at least one reference image previously coded and reconstructed,
applying an atomic decomposition method on a vector of data Ycp, comprising the image data of neighbouring blocks of the current block previously coded and reconstructed and the data of the initial prediction block, and
extracting from the decomposed vector the data corresponding to the current block, the extracted data forming the prediction block.

### 1. SCOPE OF THE INVENTION

The invention relates to the general domain of image coding.

The invention relates to a method for coding a block of a sequence of images and a corresponding method for reconstructing such a block.

### 2. PRIOR ART

In reference to FIG. 1, it is known in the art to code a current block Bc of pixels of a current image belonging to a sequence of several images by spatial or temporal prediction. For this purpose, it is known in the art to determine for the current block Bc to be coded a prediction block Bp from pixels spatially neighbouring the current block previously reconstructed in the case of spatial prediction or from pixels of images other than the current image previously reconstructed, called reference images.

During a step 12, a residue block Br is determined by extracting from the current block Bc, the prediction block Bp.

During a step 14, the residue block is coded in a stream F. This step of coding generally comprises, the transformation of the residue block into a block of coefficients, the quantizing of these coefficients and their entropy coding in a stream F.

In the case of temporal prediction, it is known in the art to determine a block of prediction pixels from a motion estimation method such as a block matching method. However, such a prediction block is generally non-homogenous with respect to neighbouring blocks of the reconstructed current block.

### 3. SUMMARY OF THE INVENTION

The purpose of the invention is to overcome at least one of the disadvantages of the prior art. For this purpose, the invention relates to a method for coding a current block of a sequence of images comprising the following steps for:
determining a prediction block for the current block,
determining a residue block by extracting from the current block the prediction block, and
coding the residue block.

According to the invention, the prediction block of the current block is determined according to the following steps for:
determining an initial prediction block from motion data and at least one reference image previously coded and reconstructed,
applying an atomic decomposition method on a vector of data Ycp, the vector of data comprising the image data of neighbouring blocks of the current block previously coded and reconstructed and the data of the initial prediction block, and
extracting from the decomposed vector the data corresponding to the current block, the extracted data forming the prediction block.

The temporal prediction of the current block is improved as the resulting prediction block combines both an item of temporal information from reference images and an item of spatial information from the current image. The resulting prediction block is made more homogenous due to the taking into account of the spatial environment, i.e. previously reconstructed neighbouring pixels, of the current block.

According to a particular aspect of the invention, the coding method comprises the determination, according to the following steps, of a vector Xₖ minimizing N(Ycp−A_{c}X), where Ac is a matrix for which each column represents an atom aj and N(.) is a standard for:
a) selecting the atom ajₖ most correlated with Rₖ₋₁ where Rₖ₋₁ is a residue calculated between the vector Y_{cp} and A_{c}*Xₖ₋₁, where Xₖ₋₁ is the value of X determined at the iteration k−1, with k an integer,
b) calculating Xₖ and Rₖ from the selected atom,
c) iterating the steps a and b up to the following stopping criterion N(Y_{cp}−A_{c}Xₖ)≦ρ, where ρ is a threshold value,
   extracting from the vector A_{c}Xₖ_{ₒₚₜ} the prediction block, where Xₖ_{ₒₚₜ} is one of the vectors Xₖ.

According to a particular characteristic of the invention, Xₖ_{ₒₚₜ}=C_{K}, where K is the index of the last iteration.

According to a variant, Xₖ_{ₒₚₜ} determined according to the following steps for:
memorizing at each iteration Xₖ,
selecting, from among the Xₖ memorized, the Xₖ for which the value N(Yₚ−AₚXₖ) is lowest, where Y_{P} is the part of Y_{cp} corresponding to the current block and Ap is the part of the matrix Ac corresponding to the current block, and
determining the prediction block from AₚXₖ_{ₒₚₜ}, where Xₖ_{ₒₚₜ} is the Xₖ opt selected in the previous step.

The invention also relates to a method for reconstruction of a current block of a sequence of images in the form of a stream of coded data comprising the following steps for:
determining a residue block by decoding a part of the stream of coded data,
determining a prediction block of the current block, and
reconstructing the current block by merging the residue block and the prediction block.

According to the invention, the prediction block of the current block is determined according to the following steps for:
determining an initial prediction block from motion data and at least one reference image previously coded and reconstructed,
applying an atomic decomposition method on a vector of data Ycp, the vector of data Ycp comprising the image data of neighbouring blocks of the current block previously coded and reconstructed and the data of the initial prediction block, and
extracting from the decomposed vector the data corresponding to the current block, the extracted data forming the prediction block.

According to a particular embodiment, the reconstruction method comprises the determination, according to the following steps, of a vector Xₖ minimizing N(Ycp−A_{c}X), where Ac is a matrix for which each column represents an atom aj and N(.) is a standard for:
a) selecting the atom ajₖ most correlated with Rₖ₋₁ where Rₖ₋₁ is a residue calculated between the vector Y_{cp} and A_{c}*Xₖ₋₁, where Xₖ₋₁ is the value of X determined at the iteration k−1, with k an integer,
b) calculating Xₖ and Rₖ from the selected atom,
c) iterating the steps a and b up to the following stopping criterion N(Y_{cp}−A_{c}Xₖ)≦ρ, where ρ is a threshold value,
   extracting from the vector A_{c}Xₖ_{ₒₚₜ} the prediction block, where Xₖ_{ₒₚₜ} is one of the vectors Xₖ.

According to a particular characteristic of the invention, Xₖ_{ₒₚₜ}=X_{K}, where K is the index of the last iteration.

According to a variant, Xₖ_{ₒₚₜ} determined according to the following steps for:
memorizing at each iteration Xₖ,
selecting, from among the Xₖ memorized, the Xₖ for which the value N(Yₚ−AₚXₖ) is lowest, where Y_{P} is the part of Y_{cp} corresponding to the current block and Ap is the part of the matrix Ac corresponding to the current block, and
determining the prediction block from AₚXₖ_{ₒₚₜ}, where Xₖ_{ₒₚₜ} is the Xₖ selected in the previous step.

### 4. LIST OF FIGURES

The invention will be better understood and illustrated by means of embodiments and advantageous implementations, by no means limiting, with reference to the figures in the appendix, wherein:

FIG. 1 shows a coding method according to the prior art,

FIG. 2 shows a method for atomic decomposition according to the prior art,

FIG. 3 shows a group of blocks of an image,

FIG. 4 shows a coding method according to the invention,

FIG. 5 shows a decoding method according to the invention,

FIGS. 6, 7 and 8 show particular elements of the coding method according to the invention,

FIG. 9 shows a method for reconstruction according to the invention,

FIG. 10 shows a coding device according to the invention,

FIG. 11 shows a decoding device according to the invention, and

FIG. 12 shows different forms of causal zones.

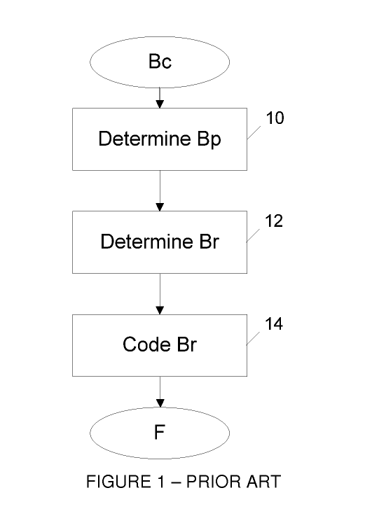

### 5. DETAILED DESCRIPTION OF THE INVENTION

An image comprises pixels or image points with each of which is associated at least one item of image data. An item of image data is for example an item of luminance data or an item of chrominance data.

The term “residue” designates the data obtained after extraction of other data. The extraction is generally a subtraction of prediction pixels from source pixels. However, the extraction is more general and comprises notably a weighted subtraction.

The term “reconstructs” designates data (for example pixels, blocks) obtained after merging of residues with prediction data. The merge is generally a sum of prediction pixels with residues. However, the merging is more general and comprises notably the weighted sum. A reconstructed block is a block of reconstructed pixels.

In reference to image decoding, the terms “reconstruction” and “decoding” are very often used as being synonymous. Thus, a “reconstructed block” is also designated under the terminology of “decoded block”.

The method for coding according to the invention is based on a method for atomic decomposition. Various methods exist enabling an atomic decomposition to be obtained from a signal Y. Among them, one of the most well known is known under the term “matching pursuit”. Note that variants of “matching pursuit” can be used such as “orthogonal matching pursuit” or “Global Matched Filter”.

The general principle of atomic decomposition in general and of “matching pursuit” is described hereafter. For Y a source vector of dimensions N and A a matrix of dimensions N×M with M>>N. The columns aⱼ of A are basic functions or atoms of a dictionary, that are used to represent the source vector Y. The purpose of the atomic decomposition of the source signal Y is to determine the vector X of dimension M such that Y=AX. There are an infinity of solutions for the vector X. The purpose of parsimonious representations is to search among all the solutions of Y=AX, for those that are parsimonious, i.e. those for which the vector X has only a low number of non-null coefficients. The search for the exact solution is too complex in practice as it requires a very costly combinatory approach. In general, a parsimonious representation is sought instead that verifies N(Y−AX)≦ρ, where ρ is a tolerance threshold that controls the parsimony of the representation and where N(.) is for example the squared standard L2. Naturally, N(.) can be a standard other than the standard L2.

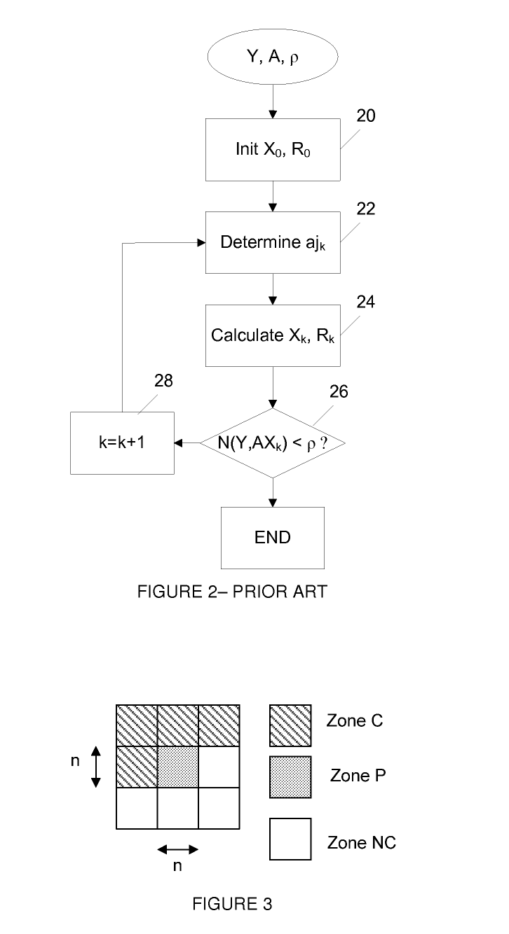

The method of “Matching Pursuit” (MP) enables such a sub-optimal, i.e. non-exact solution to be obtained, using an iterative procedure. The method generates at each iteration k, a representation Xₖ, dimension vector M, having a number of non-null coefficients that increases in general (except if the same atom is selected during two iterations) at each new iteration k. The MP method is described in detail in reference to FIG. 2.

The known data are the source signal Y, the dictionary A and the threshold p. During an initialisation step 20 (iteration k=0) X₀=0 and the initial vector of residual error R₀ is calculated as follows: R₀=Y−AX₀=Y.

During a step 22, corresponding to the k^{th} iteration, the base function aⱼ_{ₖ} having the highest correlation with the current residue vector Rₖ₋₁ is selected, where

$${R}_{k - 1} = Y - {AX}_{k - 1} . \\ {j}_{k} = {arg max}_{j} \vert 〈 {R}_{k - 1} , {a}_{j} 〉 \vert = arg {max}_{j} \frac{{( {a}_{j}^{T} {R}_{k - 1} )}^{2}}{{a}_{j}^{T} {a}_{j}}$$

During a step 24, the vector Xₖ and the residue vector Rₖ are updated.

The coefficient xⱼ_{ₖ} of the vector Xₖ is calculated according to the following formula:

$${x}_{{j}_{k}} = \frac{{a}_{{j}_{k}}^{T} {R}_{k - 1}}{{a}_{{j}_{k}}^{T} {a}_{{j}_{k}}} = \vert 〈 {R}_{k - 1} , {a}_{{j}_{k}} 〉 \vert$$

The residue vector Rₖ is updated according to the following formula:

$${R}_{k} = {R}_{k - 1} - {x}_{{j}_{k}} {a}_{{j}_{k}} = {R}_{k - 1} - \frac{{a}_{j}^{T} {R}_{k - 1}}{{a}_{j}^{T} {a}_{j}} {a}_{{j}_{k}}$$

The coefficient xⱼ_{ₖ} that has just been calculated is added to Xₖ₋₁ to thus form the new representation Xₖ

During a step 26, there is a check to see if the stopping criterion is satisfied. If N(Y−AXₖ)≦ρ then the procedure is terminated if not k is incremented by 1 during a step 28 and the procedure resumes at step 22. The final vector AX_{K} is an approximation of the source signal Y, where K is the index of the last iteration.

In FIG. 3, blocks of pixels of size n×n are shown. The integer “n” can take different values such as for example 4, 8, 16, etc. The greyed block (zone P) represents the current block to be predicted, the shaded block (zone C) represents the causal zone and the white zone (zone NC) represents the non-causal zone. The causal zone comprises pixels reconstructed previous to the current block. The definition of the causal zone depends on the order of coding of blocks in the image. In FIG. 3, the blocks are assumed to be coded according to a standard coding order known as “raster scan”. The invention is however in no way limited to this coding order. The coding method according to the invention comprises the atomic decomposition of an observation vector Y formed of pixels of the zone L scanned in line, with L=C∪P∪NC. The vector Y is thus a vector of size 9n²×1.

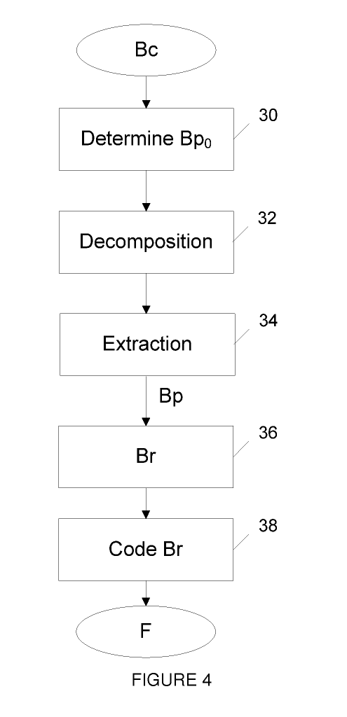

The method for coding according to the invention is described in detail in reference to FIG. 4.

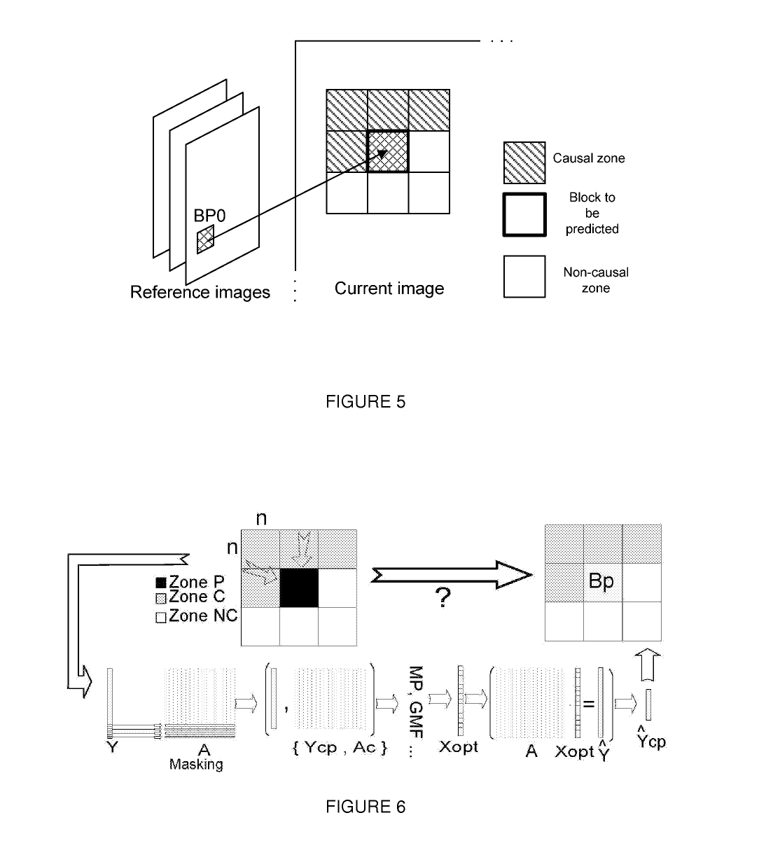

During a step 30, an initial prediction block Bp0 is determined, for example according to a standard block matching method. The block matching comprises the selection in a reference image of the block that minimises a distortion calculated between this prediction block and the current block to be predicted. Such a block Bp0 is a block of a reference image or an interpolated version of such a block. At the end of this step, neighbouring blocks are available of the current block previously reconstructed and for the current block a prediction block Bp0 is available that represents a first approximation of data of the current block as shown in FIG. 5.

During a step 32, an atomic decomposition is applied on a vector Ycp of size 5n²×1 comprising as data the values of pixels of the observation zone, i.e. of neighbouring blocks (zone C in FIG. 3) and the pixels of the initial prediction block Bp0 that has replaced the data of the current block to be predicted (zone P in FIG. 3). The data of other neighbouring blocks of the current block not previously reconstructed (zone NC on FIG. 3) are null. The union of zones C, NC and P forms a zone L of size 3n×3n. The dictionary A comprises two-dimensional base functions of the same size as the zone L (3n×3n), and that are assumed to have correct properties for the decomposition of a signal into elementary signals. It can naturally be considered to use for A, the usual transforms kernel, such as DCT (Discrete Cosine Transform) or DFT (Discrete Fourier Transform). In these specific cases, a frequency decomposition of the signal is operated. The expressions of base functions or atoms associated with the DFT and the DCT, respectively, are the following:

$${g}_{p , q} ( m , n ) = {e}^{2 i π ( \frac{m p}{M} + \frac{nq}{N} )}$$

$$and$$

$${g}_{p , q} ( m , n ) = cos ( \frac{p π ( 2 m + 1 )}{2 M} ) cos ( \frac{q π ( 2 n + 1 )}{2 N} )$$

The dictionary A must comprise at minimum 9n² atoms to represent the zone L. In order to be able to contain 9n² two-dimensional atoms for which the size of each is 3n×3n in a 2D matrix, the atoms must be vectored. Thus, the dictionary A is constituted of 9n² columns each one of which represents an atom of size 9n²×1. The dictionary A is thus of dimensions 9n²×9n².

The choice of DCT and DFT atoms is not a limitation. In fact, the dictionary can be enriched from any base functions able to represent any pattern type in an image (Gabor atoms, anisotropic atoms, etc.). The number of atoms or again, the number of columns in the matrix A has as a minimum value, the size of the vectored zone L (i.e. 9n²) but does not have a theoretical maximum value. The more the quantity of atoms is great, the more chance there is of recovering the signal.

The only useful pixels are those of zones C and P, the other pixels being null. It is this observation vector Y_{cp} that will be the prediction support useful to the MP method.

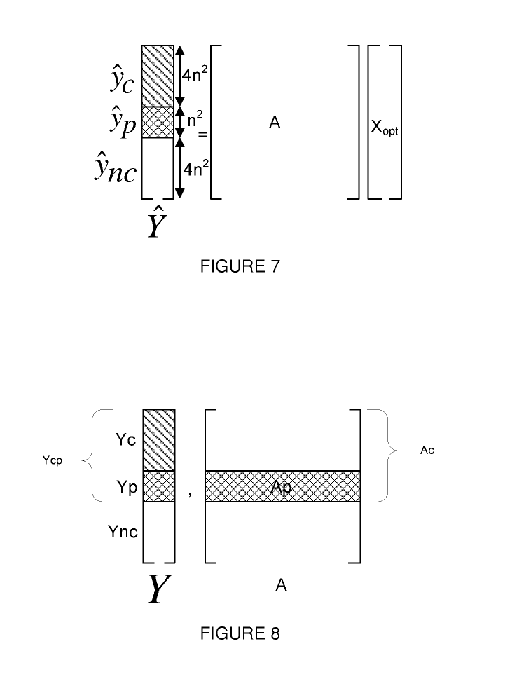

During a step 34, the vector Ŷₚ of size n² that corresponds to the zone P is extracted from Ŷ as shown in FIG. 7. The data Ŷₚ extracted are reorganised (inverse operation to the vectoring operations) in block form. The reorganised data represent the new prediction block Bp of the current block. This prediction block Bp is more homogenous than Bp0 due notably to the account taken of the spatial environment of the current block.

During a step 36, the residue block Br is determined by extracting from the current block Bc, the prediction block Bp, for example by subtraction pixel by pixel.

During a step 38, the residue block is coded. This coding step generally comprises, the transformation of the residue block into a block of coefficients, the quantizing of these coefficients and their entropy coding in a stream F. According to a variant, it can comprise the quantizing of residues and their entropy coding in a stream F.

According to a variant, the set of sequences Xₖ determined during the iterations (step 24 of the MP method) are stored in the memory. Xₒₚₜ is no longer equal to X_{K}, K being the index of the last iteration but Xₒₚₜ=Xₖ_{ₒₚₜ} with

$${k}_{opt} = {min}_{k ∈ [ 1 , K ]} N ( {Y}_{p} - {A}_{p} {X}_{k} )$$

where:
A_{P} is the matrix of size n²×9n² associated with the zone P to be predicted, and
Yₚ is the vector of size n²×1 associated with the zone P to be predicted.

Ap and Yp are shown in FIG. 8. This variant enables Xₒₚₜ to be determined as being the best representation of the zone P that does not necessarily correspond to the best representation on the zone C∪P. The data AₚXₖ_{ₒₚₜ} are reorganised (inverse operation to the vectoring operations) in block form. According to this variant, the coefficient kₒₚₜ is also coded in the stream F. In fact, the data of the vector Y_{P} are unknown to the decoder. The reorganised data represent the new prediction block Bp of the current block.

In a standard coding method, this coding mode can replace the standard coding mode by temporal prediction corresponding to Bp0 or it may compliment it, the two modes being tested by a coding mode decision module and the mode offering the best bitrate-distortion compromise being retained.

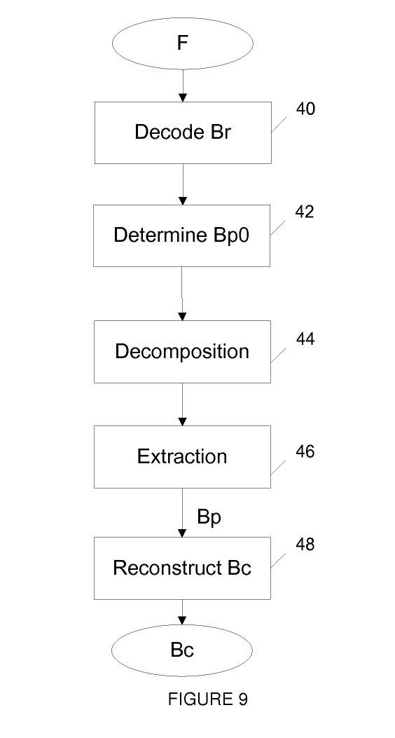

FIG. 9 diagrammatically shows a method for reconstruction of a current block according to the invention.

During a step 40, a residue block Br is decoded for the current block. For example, a part of the stream F is decoded into coefficients. The coefficients are dequantized then if necessary transformed by an inverse transform to that used on the coder side in step 14. A residue block is thus obtained. According to a variant, the inverse transformation step is omitted notably if no transformation step has been applied on the coder side in step 14.

During a step 42, an initial prediction block Bp0 is determined, for example from one or several motion vectors decoded from the stream F. According to a variant, the initial prediction block Bp0 is determined by a “template matching” technique. Such a technique is notably described in the document by T. K. Tan et al entitled “Intra prediction by template matching” and published during the ICIP conference in 2006.

Such a block Bp0 is a block of a reference image or an interpolated version of such a block. At the end of this step, neighbouring blocks of the current block previously reconstructed are available and, for the current block a prediction block Bp0 is available that represents a first approximation of data of the current block as shown in FIG. 5.

During a step 44, an atomic decomposition is applied on a vector Y of size 9n²×1 comprising as data the values of pixels of the observation zone, i.e. of neighbouring blocks (zone C in FIG. 3) and the pixels of the initial prediction block Bp0 that has replaced the data of the current block to be predicted (zone P in FIG. 3) and null values to represent the data of other neighbouring blocks of the current block not previously reconstructed (zone NC in FIG. 3). The union of zones C, NC and P forms a zone L of size 3n×3n. The dictionary A comprises two-dimensional base functions of the same size as the zone L (3n×3n), and that are assumed to have correct properties for the decomposition of a signal into elementary signals. It can naturally be considered to use for A, the usual transforms kernel, such as the DCT (Discrete Cosine Transform) or the DFT (Discrete Fourier Transform). In these specific cases, a frequency decomposition of the signal is operated. The expressions of base functions or atoms associated with the DFT and the DCT, respectively, are the following:

$${g}_{p , q} ( m , n ) = {e}^{2 i π ( \frac{m p}{M} + \frac{nq}{N} )}$$

$$and$$

$${g}_{p , q} ( m , n ) = cos ( \frac{p π ( 2 m + 1 )}{2 M} ) cos ( \frac{q π ( 2 n + 1 )}{2 N} )$$

The dictionary A must comprise at minimum 9n² atoms to represent the zone L. In order to be able to contain 9n² two-dimensional atoms for which the size of each is 3n×3n in a 2D matrix, the atoms must be vectored. Thus, the dictionary A is constituted of 9n² columns each one of which represents an atom of size 9n²×1. The dictionary A is thus of dimensions 9n²×9n².

The choice of DCT and DFT atoms is not a limitation. In fact, the dictionary can be enriched from any base functions able to represent any pattern type in an image (Gabor atoms, anisotropic atoms, etc.). The number of atoms or again, the number of columns in the matrix A has as a minimum value, the size of the vectored zone L (i.e. 9n²) but does not have a theoretical maximum value. The more the quantity of atoms is great, the more chance there is of recovering the signal.

The only useful pixels are those of zones C and P, the other pixels being null. Note Y_{cp} of dimensions equal to 5n²×1 pixels, the vector containing only the pixels of the causal zone C and of the initial prediction block Bp0. It is this observation vector Y_{cp} that will be the prediction support useful to the MP method.

As shown in FIG. 6, in order to be able to represent the data of Y_{cp} that is of dimensions 5n²×1 (and not those of Y), the matrix A is modified by removing its lines corresponding to all the pixels outside the zone C and P. In fact, all these pixels are unknown and have a value of zero. A matrix is thus obtained, noted as A_{c}, compacted in the sense of the height, of size 5n²×9n². The matching pursuit method or another equivalent method is used to determine among the set of parsimonious solutions of the problem Y_{cp}=A_{c}X, that noted as Xₒₚₜ that minimises the reconstruction error. The steps 20 to 28 described in reference to FIG. 2 are thus applied iteratively in order to determine Xₒₚₜ with as observation data the vector Y_{cp} and as dictionary the matrix A_{c}. The method stops as soon as the stopping criterion N(Y_{cp}−A_{c}Xₖ)≦ρ is verified: Xₒₚₜ=X_{K}, K being the index of the last iteration. The final vector Ŷ=AXₒₚₜ is an approximation of the vector Y.

During a step 46, the vector Ŷₚ of size n² that corresponds to the zone P is extracted from Ŷ as shown in FIG. 7. The data Ŷₚ extracted are reorganised (inverse operation to the vectoring operations) in block form. The reorganised data represent the new prediction block Bp of the current block. This prediction block Bp is more homogenous than Bp0 due notably to the account taken of the spatial environment of the current block.

During a step 48, the current block Bc is reconstructed by merging the prediction block Bp determined in step 46 and the residue block decoded in step 40, for example by addition pixel by pixel.

According to a variant, an index Kₒₚₜ is decoded from the stream F. Xₒₚₜ is no longer equal to X_{K}, K being the index of the last iteration but Xₒₚₜ=Xₖ_{ₒₚₜ}.

This variant enables Xₒₚₜ to be determined as being the best representation of the zone P that does not necessarily correspond to the best representation on the zone C∪P. The data AₚXₖ_{ₒₚₜ} are reorganised (inverse operation to the vectoring operations) in block form. The reorganised data represent the new prediction block Bp of the current block.

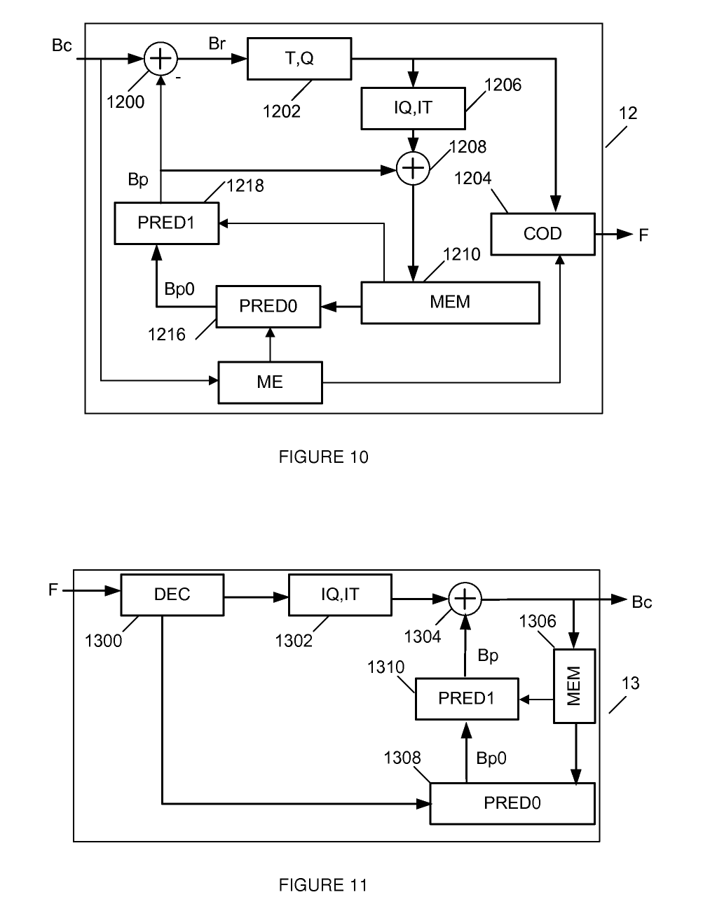

FIG. 10 diagrammatically shows a coding device 12. The coding device 12 receives at input an image or images. The coding device 12 is able to implement the coding method according to the invention described in reference to FIG. 4. Each image is divided into blocks of pixels with each of which is associated at least one item of image data. The coding device 12 notably implements a coding with temporal prediction. Only the modules of the coding device 12 relating to the coding by temporal prediction or INTER coding are shown in FIG. 9. Other modules known by those skilled in the art of video coders are not shown (for example selection of the coding mode, spatial prediction). The coding device 12 notably comprises a calculation module 1200 able to extract, for example by subtraction pixel by pixel, from a current block Bc a prediction block Bp to generate a residue block Br. The calculation module 1200 is able to implement step 36 of the coding method according to the invention. It further comprises a module 1202 able to transform then quantize the residue block Br into quantized data. The transform T is for example a Discrete Cosine Transform (DCT). The coding device 12 also comprises an entropy coding module 1204 able to code the quantized data into a stream F. It also comprises a module 1206 performing the inverse operation of the module 1202. The module 1206 carries out an inverse quantization Q⁻¹ followed by an inverse transformation T⁻¹. The module 1206 is connected to a calculation module 1208 capable of merging, for example by addition pixel by pixel, the block of data from the module 1206 and the prediction block Bp to generate a reconstructed block that is stored in a memory 1210.

A first prediction module 1216 determines an initial prediction block Bp0. The first prediction module 1216 is able to implement step 30 of the coding method according to the invention. The coding device 12 comprises a second prediction module 1218. The second prediction module 1218 determines a prediction block Bp from data already reconstructed stored in the memory 1210 and from the initial prediction block Bp0. The second prediction module 1218 is able to implement steps 32 and 34 of the coding method according to the invention.

Step 38 of the coding method is implemented in the modules 1202 and 1204.

FIG. 11 diagrammatically shows a decoding device 13. The decoding device 13 receives at input a stream F representative of an image. The stream F is for example transmitted by a coding device 12 via a channel. The decoding device 13 is able to implement the decoding method according to the invention described in reference to FIG. 9. The decoding device 13 comprises an entropy decoding module 1300 able to generate decoded data. The decoded data are then transmitted to a module 1302 able to carry out an inverse quantization followed by an inverse transform. The module 1302 is identical to the module 1206 of the coding device 12 having generated the stream F. The module 1302 is connected to a calculation module 1304 able to merge, for example by addition pixel by pixel, the block from the module 1302 and a prediction block Bp to generate a reconstructed current block Bc that is stored in a memory 1306. The calculation module 1304 is able to implement step 48 of the reconstruction method. The decoding device 13 comprises a prediction module 1308. The prediction module 1308 determines the initial prediction block Bp0. The prediction module 1308 is able to implement step 42 of the reconstruction method according to the invention. It also comprises a second prediction module 1310. The second prediction module 1310 determines a prediction block Bp from data already reconstructed stored in the memory 1306 and from the initial prediction block Bp0. The second prediction module 1310 is able to implement steps 44 and 46 of the reconstruction method according to the invention. Step 40 of the reconstruction method is implemented in the modules 1300 and 1302.

Naturally, the invention is not limited to the embodiment examples mentioned above.

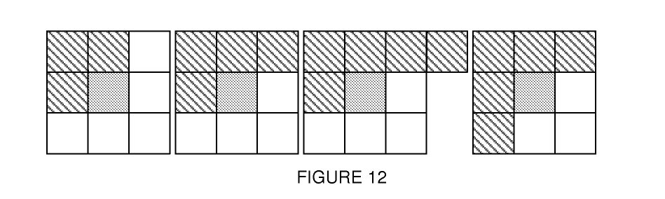

In particular, those skilled in the art may apply any variant to the stated embodiments and combine them to benefit from their various advantages. In fact, other methods than the matching pursuit method can be used to determine the vector Xₒₚₜ. Likewise the form of the causal zone can vary as shown in FIG. 12. In this figure, the causal zone taken into account is shaded. The invention is in no way limited to these forms of causal zones that are only shown as an illustrative example. In this figure the blocks are of any size. The causal zone can be in any position with respect to the prediction block, in the sense that the method according to the invention is independent of the scanning order of blocks in the image. In the embodiment described in reference to FIG. 5, the initial temporal prediction Bp0 is derived from a reference image situated before the current image in the display order corresponding to a type P temporal prediction. The invention is not limited to this prediction type. In fact, the prediction block BP0 can result from a prediction from a reference image situated after the current image in the display order. It can also result from a bi-directional or bi-predicted prediction.

1. A method for coding a current block of a sequence of images comprising the following steps for:
determining, for said current block, a prediction block,
determining a residue block from said current block and from said prediction block,
coding said residue block,
wherein said prediction block is determined according to the following steps for:
determining an initial prediction block from at least one motion vector and at least one reference image,
applying an atomic decomposition of a vector Ycp comprising the image data of reconstructed neighbouring blocks of said current block and the data of the initial prediction block, and
extracting from said decomposed vector the data corresponding to said current block and reorganizing said extracted data into said prediction block.

2. A method for coding according to claim 1, wherein applying an atomic decomposition comprises:
a) selecting the atom ajₖ most correlated with Rₖ₋₁ where Rₖ₋₁ is a residue calculated between the vector Y_{cp} and A_{c}*Xₖ₋₁, where Xₖ₋₁ is the value of X determined at the iteration k−1, with k an integer, Ac is a matrix for which each column represents an atom aj and N(.) is a standard,
b) calculating Xₖ and Rₖ from said selected atom,
c) iterating the steps a and b up to the following stopping criterion N(Y_{cp}−A_{c}Xₖ)≦ρ, where ρ is a threshold value.

3. A method for coding according to claim 9, wherein Xₖ_{ₒₚₜ}=X_{K}, where K is the index of the last iteration.

4. A method for coding according to claim 9, wherein Xₖ_{ₒₚₜ} is determined according to the following steps:
memorizing at each iteration Xₖ,
selecting, from among the Xₖ memorized, the Xₖ for which the value N(Yₚ−Aₚ×Xₖ) is lowest, where Y_{P} is the part of Y_{cp} corresponding to the current block and Ap is the part of the matrix Ac corresponding to the current block, and
determining the prediction block from AₚXₖ_{ₒₚₜ}, where Xₖ_{ₒₚₜ} is the Xₖ selected in the previous step.

5. A method for reconstruction of a current block of a sequence of images in the form of a stream of coded data comprising the following steps for:
determining a residue block by decoding a part of said stream of coded data,
determining, for said current block, a prediction block,
reconstructing said current block from said residue block and from said prediction bock,
wherein said prediction block is determined according to the following steps for:
determining an initial prediction block from at least one motion vector and at least one reference image,
applying an atomic decomposition method on a vector Ycp comprising the image data of reconstructed neighbouring blocks of said current block and the data of the initial prediction block, and
extracting from said decomposed vector the data corresponding to said current block and reorganizing said extracted data into said prediction block.

6. A method for reconstruction according to claim 5, wherein applying an atomic decomposition comprises:
a) selecting the atom ajₖ most correlated with Rₖ₋₁ where Rₖ₋₁ is a residue calculated between the vector Y_{cp} and A_{c}*Xₖ₋₁, where Xₖ₋₁ is the value of X determined at the iteration k−1, with k an integer,
b) calculating Xₖ and Rₖ from said selected atom,
c) iterating the steps a and h up to the following stopping criterion N(Y_{cp}−A_{c}Xₖ)≦ρ, where ρ is a threshold value.

7. A method for reconstruction according to claim 10, wherein Xₖ_{ₒₚₜ}=X_{K}, where K is the index of the last iteration.

8. A method for reconstruction according to claim 10, wherein Xₖ_{ₒₚₜ} is determined according to the following steps for:
memorizing at each iteration Xₖ,
selecting, from among the Xₖ memorized, the Xₖ for which the value N(Yₚ−AₚXₖ) is lowest, where Y_{P} is the part of Y_{cp} corresponding to the current block and Ap is the part of the matrix Ac corresponding to the current block, and
determining the prediction block from AₚXₖ_{ₒₚₜ}, where Xₖ_{ₒₚₜ} is the Xₖ selected in the previous step.

9. A method for coding according to claim 2, wherein extracting from said decomposed vector the data corresponding to said current block comprises
extracting from the vector A_{c}Xₖ_{ₒₚₜ} the prediction block, where Xₖ_{ₒₚₜ} is one of the vectors Xₖ.

10. A method for reconstruction according to claim 6, wherein extracting from said decomposed vector the data corresponding to said current block comprises
extracting from the vector A_{c}Xₖ_{ₒₚₜ} the prediction block, where Xₖ_{ₒₚₜ} is one of the vectors Xₖ.

11. A device for coding a current block of a sequence of images comprising the following:
means for determining, for said current block, a prediction block,
means for determining a residue block from said current block and from said prediction block,
means for coding said residue block,
wherein said means for determining, for said current block, a prediction block comprise:
means for determining an initial prediction block from at least one motion vector and at least one reference image,
means for applying an atomic decomposition of a vector Ycp comprising the image data of reconstructed neighbouring blocks of said current block and the data of the initial prediction block, and
means for extracting from said decomposed vector the data corresponding to said current block and for reorganizing said extracted data into said prediction block.

12. A device for coding according to claim 11, wherein said device is adapted to execute the steps of the method for coding.

13. A decoding device for the reconstruction of a current block of a sequence of images in the form of a stream of coded data comprising:
means for determining a residue block by decoding a part of said stream of coded data,
means for determining, for said current block, a prediction block,
means for reconstructing said current block from said residue block and from said prediction block,
wherein said means for determining, for said current block, a prediction block comprise:
means for determining an initial prediction block from at least one motion vector and at least one reference image,
means for applying an atomic decomposition method on a vector Ycp comprising the image data of reconstructed neighbouring blocks of said current block and the data of the initial prediction block, and
means for extracting from said decomposed vector the data corresponding to said current block and for reorganizing said extracted data into said prediction block.

14. A decoding device according to claim 13, wherein said device is adapted to execute the steps of the method for reconstruction.
